(19) United States
(12) Patent Application Publication
(10) Pub. No.: US 2025/0288497 A1
(43) Pub. Date: Sep. 18, 2025

(54) Automated Pill Dispenser

(71) Applicant: Anisha Vaish, Kirkland, WA (US)

(72) Inventor: Anisha Vaish, Kirkland, WA (US)

(21) Appl. No.: 18/608,070

(22) Filed: Mar. 18, 2024

Related U.S. Application Data
(60) Provisional application No. 63/491,059, filed on Mar. 18, 2023.

(51) Int. Cl. A61J 7/04; B65D 83/04

(52) U.S. Cl. CPC A61J 7/0463; B65D 83/0409

(57) ABSTRACT

Millions of people take different medications multiple times a day and need to manually sort medicines into pill organizers, which can cause medication inaccuracies. There is an urgent need for a home-based pill dispenser system to keep track of dosage and its changes in real time, be user friendly, and dispense pills per dose and timing without the need to sort out pills in advance. This invention describes a pill dispenser system with custom designed wheel rotation systems containing grooves on the wheel for specific pill sizes to receive pills one at a time from a receptacle above in the groove of the wheel, and with desired wheel rotation dispense the pill into a receptacle below. The rotation of the wheel is controlled by a 5V stepper motor, an Arduino™, and a custom Android™ application.

### CROSS-REFERENCE TO RELATED APPLICATION

This application claims the benefit of U.S. Provisional Application No. 63/491,059, filed on Mar. 18, 2023, which is hereby incorporated by reference in its entirety. In cases in which a document incorporated by reference herein is inconsistent with contents of this application, the contents of this application control.

### FIELD OF THE INVENTION

The present invention relates to an automatic electronic pill dispenser system. More specifically this invention pertains to a system to dispense medical pills in a desired quantity and at specific times of the day.

### BACKGROUND OF THE INVENTION

Millions of people in the world take medications and a large number of them take multiple different medications prescribed by more than one doctor at multiple times a day. It is difficult for patients, especially older patients or patients with disability or cognitive difficulty, to keep track of these medications (in the form of pills) and take them correctly. This can lead to discrepancies in which pills the patient is supposed to take and what pills the patient is actually taking. Additionally, these patients spend a lot of time either opening pill bottles several times a day to take medications or they take these pills out in pill organizers weekly. Importantly, older patients can have trouble taking these pills out in pill organizers and may be confused between different pills; often their family members have to help them by taking the pills out in the pill boxes. Sometimes family has to travel to the patient's home to sort out pills into pill organizers. Some solutions to the problem include having pills prepackaged in various bubble wraps or pill pouches and delivered them to the patient's home one month at a time. However, if the medicines need to be changed within the one month of dispensed pills, it is highly burdensome for a patient to change the pill schedule and they are often unable to change the medication schedule correctly.

There is an urgent need to have a home-based pill dispenser system which can dispense pills per dose into various compartments without the need to sort out pills in advance. The pill dispenser system should be able to react to dosage changes in real time and be user friendly.

### SUMMARY OF THE INVENTION

A pill dispenser system is described with a user interface to dispense pills into a desired compartment or a container at preprogrammed times set by the user utilizing a custom designed wheel rotation system. The interface was established for the programming of pill doses and times and to remind the user to take their medicine.

The invention is a pill dispenser system that is controlled electronically using an Arduino™ board or a microchip to dispense desired number of pills at a desired time. One feature of the invention is a wheel with one to three grooves or notches of different shapes for receiving pills of different shape and sizes from a chamber above and dispensing the pills into a chamber or a cup below. The number of pills and the time at which to dispense the pills are controlled by an Android™ application using a custom Unity Hub™ software. Other software can be used instead of Unity Hub™ software to control the Android™ application.

Various other objects, features, and advantages of the invention will become apparent to those ordinarily skilled in the art upon review of the following description of specific embodiments of the invention in conjunction with the accompanying figures.

### BRIEF DESCRIPTION OF DRAWINGS

Embodiments of the present invention will now be described, by way of example only, with reference to the attached Figures.

FIG. 1. Pseudo code for the Android™ app.

FIG. 2. Pseudo code for the Arduino Mega™.

FIG. 3. Design of an electronic circuit for one pill dispensing unit.

FIG. 4. Design of a pill dispensing unit a pill holding chamber.

FIG. 5. Design of the pill dispensing unit with an alternate pill holding chamber containing a sloping platform for pill to be dropped into a pill receiving wheel/gear below.

FIG. 6. Encasing chamber of the pill dispensing unit to hold the wheel/gear.

FIG. 7. The wheel/gear showing grooves of different sizes to receive different size pills.

FIG. 8. The pill holding chamber of the pill dispensing unit.

FIG. 9. The sloping pill base of the pill dispensing unit.

FIG. 10. The pill holding chamber lid.

FIG. 11. The design of a unit showing the wheel/gear in the module connected to a stepper motor.

FIG. 12. The assembly of five pill dispensing units without the pill holding chambers.

FIG. 13. The assembly of the five pill dispensing units with the pill holding chambers.

FIG. 14. Bottom view of the assembly of five units showing a pill receiving funnel module to dispense pills in the cup below (not shown).

### DETAILED DESCRIPTION OF THE INVENTION

In view of the great need to assist elderly and/or disabled people with compliance with their medications, the systems, methods, and apparatus described herein provide the avenues to dispense predetermined doses of medications in terms of number of pills required for the proper dose of medication at a specific time of day at a specific date, along with technical features, benefits and advantages below described for the various aspects and embodiments summarized below.

Materials needed to build one such system are described as follows but not limited to these items: An Arduino Mega™ (AtMega2560) board was used for main logic circuit design. An ESP-01S ESP8266 Wi-Fi™ Module was used to connect the Android™ application on a cell phone to the Arduino™ board and instruct the dispensation of pills at a desired time. The cell phone can be an iPhone™, an Android™ phone, or another cell phone. A 5V DC stepper motor 28BYJ-48 was used to connect and rotate custom designed wheels with notch(es). An ULN2003-Darlington array was used to drive the stepper motor. A RTC DS3231 Extremely Accurate I2C-Integrated RTC/TCXO/Crystal was used for the time and calendar register. An ELEGOO UNO™ R3 2.8 Inches TFT touch screen was used to control the system operation. A 3D printer was used to print the designed wheels and compartment components of the system.

Software codes to control the operation of the 5V motors and control the timing and number of pills to dispense were as follow: A firmware code (firmware software) for Arduino™ and a software code (Android™ application software) were developed using two open source developing tools. The Arduino Integrated Development Environment (IDE) (www.arduino.cc) is a cross-platform application that is written in functions from C. The IDE application was used to write and upload programs to the Arduino Mega™ board to control the rotation of the wheels and the motors, Wi-Fi™ connection, and the clock. The Unity Hub™ (unity.com) was used to develop the Android™ application for testing, timing, and controlling the number of pills to be dispensed.

Arduino Integrated Development Environment (IDE): The Arduino IDE was used to write and upload programs to the Arduino Mega™ board. The firmware code controls the rotation of the motor to position the notch on the wheel to receive pills from a container above, and after receiving the pill, rotate 140 degrees to dispense the pill in a receptacle below.

Unity Hub™: The Unity Hub™ software was customized to operate from a cell phone to check the time and number of pills to be dispensed and send the instructions to the Arduino™ board to dispense the pills at a desired time.

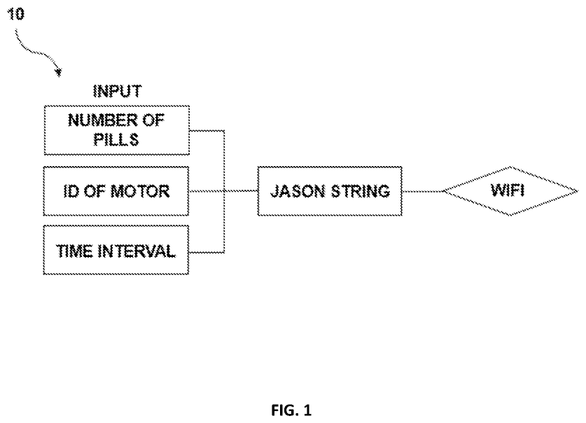

Pseudo code for the Android™ application: FIG. 1 shows a flow chart of code 10 for the Android™ application customized using Unity Hub™. The number of pills, time interval or a time and date, and ID of the motor i.e. the ID of the unit is input on Android™ phone interface. The input goes through a JASON (JavaScript Object Notation) string and is transmitted to the pill dispenser system. A touchscreen display can also be used instead of the cell/mobile phone to input the data. When the touchscreen hardcoded with the pill dispenser system is used to input data, the input command is directly sent to the pill dispenser system without the need of the Wi-Fi™.

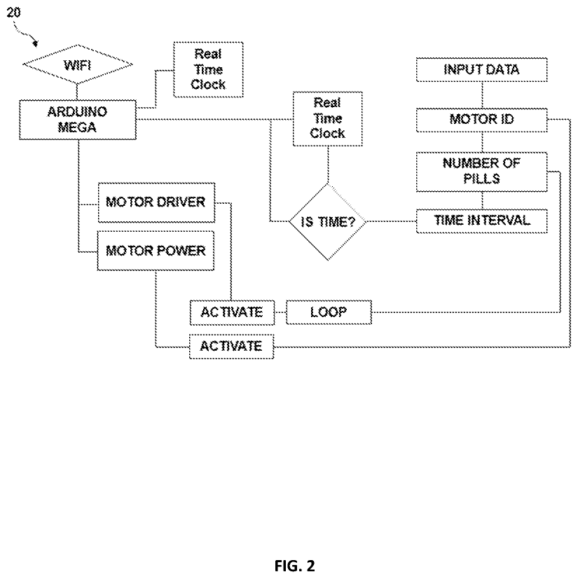

Pseudo code for the Arduino Mega™: FIG. 2 shows a flow chart of code 20 for the Arduino Mega™. The system is not limited to use Arduino Mega™ but any Arduino™ board such as Arduino Uno™ or a microchip could be used to store the code and operate the machine. The replacement of the Arduino™ board with a microchip is desired to miniaturize the pill dispenser system. The input data such as the motor ID, number of pills to be dispensed, and/or time interval from the Android™ application code 10 is received by the Arduino Mega™, at the desired and predefined time as read from a real time clock linked to the Arduino Mega™, the Arduino™ code sends commands to turn on the motor power and turn the motor driver for a specific degree of rotation to turn the wheel for a specific angle to receive a pill from the pill chamber above and rotate the motor back for same degrees of rotation to bring the wheel to the prior position and drop the pill below to a pill receiving chamber. If more than one pill is desired, the motor will operate for the same number of times as the desired number of pills.

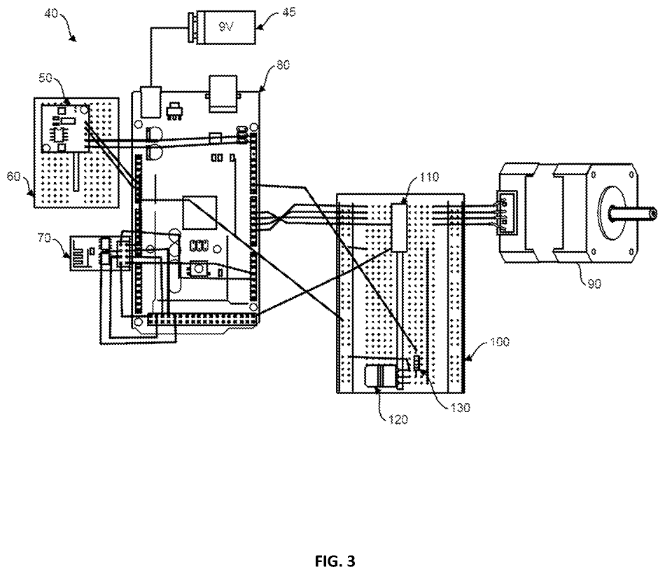

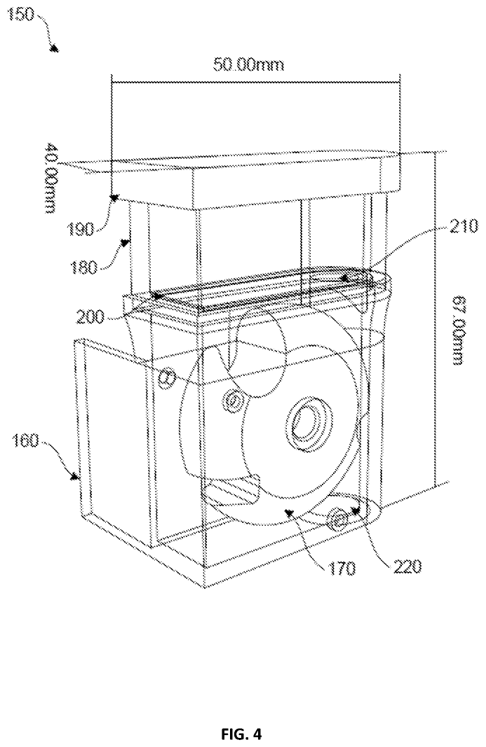

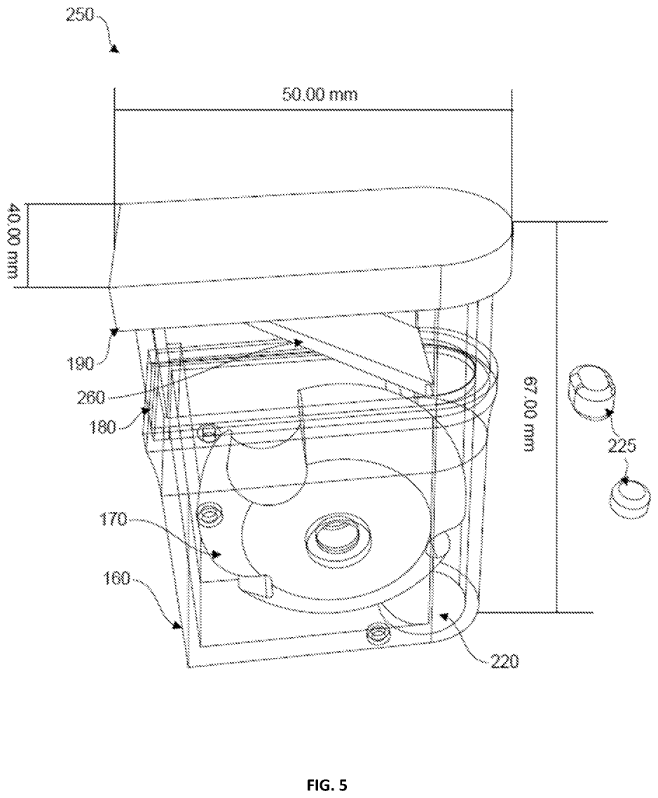

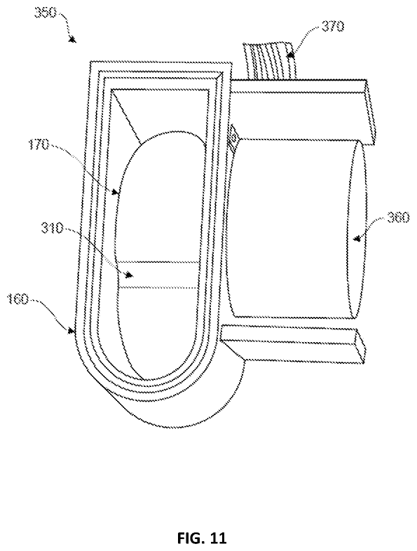

FIG. 3 shows the electronic circuit diagram 40 of one module/unit of the pill dispenser system. The operation of the system is controlled by the Arduino Mega™ board 80. The Arduino Mega™ can be replaced by a smaller microchip to make the system size small without compromising the function of the system. The real time clock module 50 is connected to the Arduino Mega™ board 80 via a breadboard 60 that provides accurate time and date. A Wi-Fi™ module 70 is connected to the Arduino Mega™ board 80 to connect to the Android™ application 10 on a cell/mobile phone. The touchscreen display is directly connected, not shown here, to the Arduino Mega™ board 80 when the data are directly fed instead of the cell/mobile phone via the Wi-Fi™ module wirelessly. The stepper motor 90 is connected to the Arduino Mega™ board 80 via a breadboard 100 to control the rotation of the wheel 170, not show in FIG. 3, but as shown in FIG. 4, FIG. 5 and FIG. 11. The rotation of the stepper motor 90 is controlled by a Darlington array 110 which is connected to the motor via the breadboard 100. The breadboards allow a temporary connections between electronic components without soldering. A power transistor 120 controls high currents and voltages, and is provided to amplify or switch electronic signals. The power transistor on the breadboard 100 allows to create circuits that control the motors, LEDs, buzzers, and other devices that require more power than a typical microcontroller can provide. Three pins of the power transistor are connected to the breadboard 100. The resistor 130 is used to provide the resistance to high voltage power and is used to protect LEDs, divide voltage, and provide precise current values for circuits. A LED directly connected to 9V power supply will burn out quickly. The resister 130 limits the current flowing through the LED so that the LED is not burnt out. A 9V battery 45 powers the system. Alternately, the system can be directly supplied with power via an electrical outlet.

FIG. 4 shows the design of the pill dispensing unit 150. The pill holding chamber 180 and the tilted ground part, a sloping pill base 200 forms the base of the pill holding chamber 180 make a compartment to hold pills to be dispensed. The sloping pill base 200 contains a round opening 210 through which the pill is dropped on to the wheel/gear 170 via gravity. The system is not limited to this design but could be designed to make a column where the pills can be aligned in a column for easy drop one at a time when the wheel/gear 170 makes a turn to receive the pill. Additionally, an iris valve could be installed in the opening 210 which is electronically controlled by the Arduino Mega™ 80 to allow only one pill to drop below on to the wheel/gear 170. The wheel/gear 170 with custom grooves to receive pills from the pill holding chamber 180 and successfully drop pills in the cup underneath (not shown). The lid 190 makes the cover of the pill holding chamber 180. The parts the unit were designed and 3D printed. However, the individual parts can be prepared by a press method or by carving from solid pieces. The machine unit was assembled by attaching the pill wheel/gear 170 with the stepper motor 360 as shown in FIG. 11 (the stepper motor 90 in FIG. 3), which was in turn connected to the Arduino Mega™ circuit board 80 via the Darlington array 110, as shown in FIG. 3, to control the rotation of the motor. The wheel/gear 170 is situated in an encasing chamber 160 of the pill dispensing unit 150 such that the encasing chamber 160 allows free rotation of the wheel/gear 170 when the wheel/gear is attached to the stepper motor. The bottom of the encasing chamber 160 contains an opening 220 to allow the pill to pass through to the cup underneath when the pill is dropped by the wheel/gear 170. The pill dispensing unit 150 is 67.00 mm in height, 50.00 mm in length, and 40.00 mm in width as should in FIG. 4. However, the pill dispensing unit could be larger or smaller depending upon the size and number of pills desired to be stored in the pill dispensing unit.

FIG. 5 shows an alternate design 250 of the pill dispensing unit 150, where the sloping pill base 200 in FIG. 4 is replaced by a higher angled sloping pill base 260 of the pill holding chamber 180 to allow dropping pills one at a time. Two pills 225 are shown for comparison.

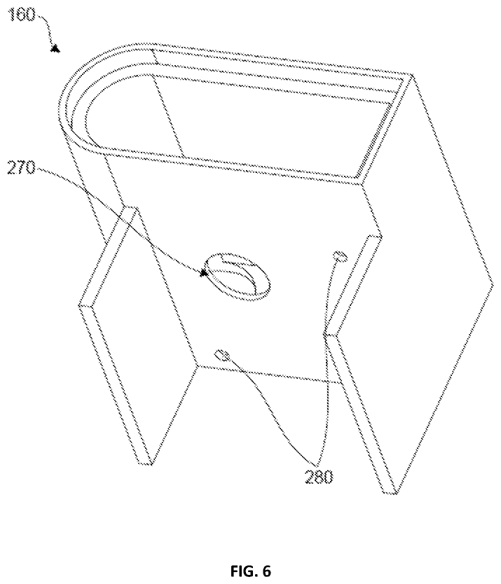

FIG. 6 shows the design of the encasing chamber 160 which contains an opening 270 for the rod of the stepper motor 360 to pass through which supports the wheel/gear 170. The slots 280 are designed for screws to affix the stepper motor 360.

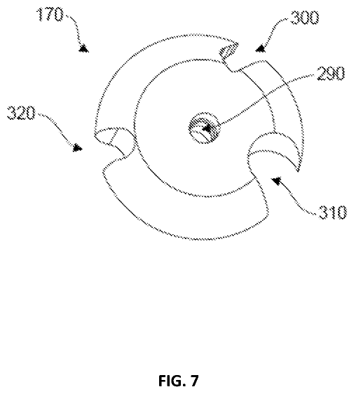

FIG. 7 shows the design of wheel/gear 170. The wheel contains an opening 290 which is used to fasten the wheel 170 to the rod of the stepper motor 360 allowing the rotation of wheel by the motor 360. The wheel 170 is shown to contain three grooves of different sizes 300, 310, and 320 to receive different size pills from the pill chamber 180 above. The wheel may contain one or two or three grooves depending upon the rotation of the wheel and the shape and size of the pill. The depth of the grooves is designed depending on the size of the pill. Preferably, the wheel contains either one or two grooves for easy operation of the unit.

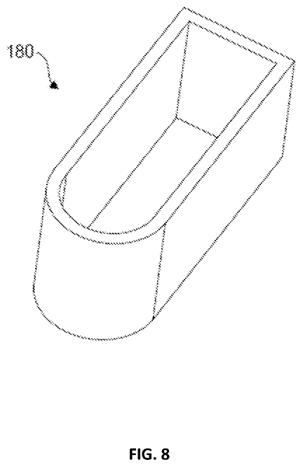

FIG. 8 shows the pill holding chamber 180 of the pill dispensing unit. The pill holding chamber is rounded on one end and right angled on the other end. However, chamber could be square, rectangle, rounded on both ends, or round.

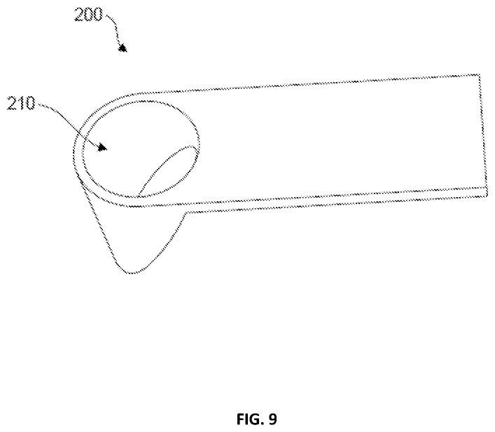

FIG. 9 shows the sloping pill base 200 of the pill dispensing unit 150. The opening 210 allows passage of pills under gravity.

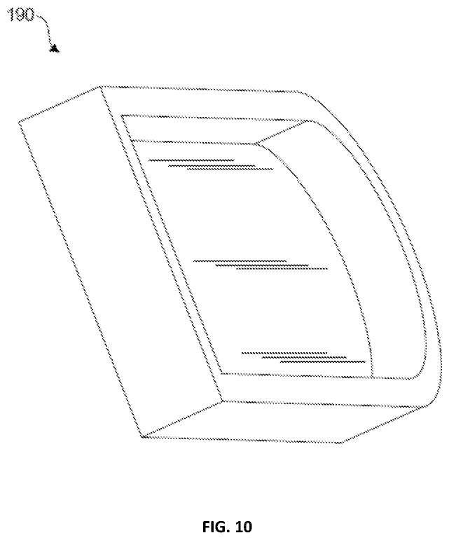

FIG. 10 shows the design of the lid 190 that fits the pill holding chamber 180. As shown, the lid 190 is rounded on one end and right angled on the other end to snugly fit the pill holding chamber. However, the lid could be square, rectangle, rounded on both ends, or round depending on the shape of the pill holding chamber 180.

FIG. 11 shows the assembly of the unit 350 where the wheel/gear 170 is situated in the encasing chamber 160 and the wheel is connected to the stepper motor 360 via the rod of the stepper motor. The groove 310 is shown on the wheel. The electrical wires 370 supply the power to the stepper motor for rotation.

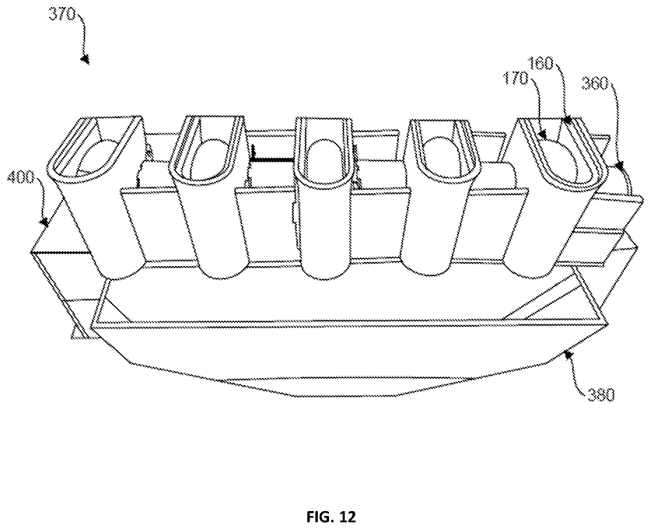

FIG. 12 shows the assembly of a unit 370 with five pill dispensing units 150 without the pill holding chambers 180. The five pill dispensing units are arranged in a row. The unit 370 can contain 1 to 50 pill dispensing units depending on the number of different types of pills and pill dispensing units 150 may be arranged in a row or in an array format of multiple rows. The chamber 400 contains the battery 45, the Arduino Mega™ board 80, the real time clock module 50, the breadboard 60, the Wi-Fi™ module 70, and the breadboard 100 along with the Darlington array 110 and the power transistor 120 of the electronic system 40. The module 380 is the funnel to receive pills dropped from the pill dispensing units 150.

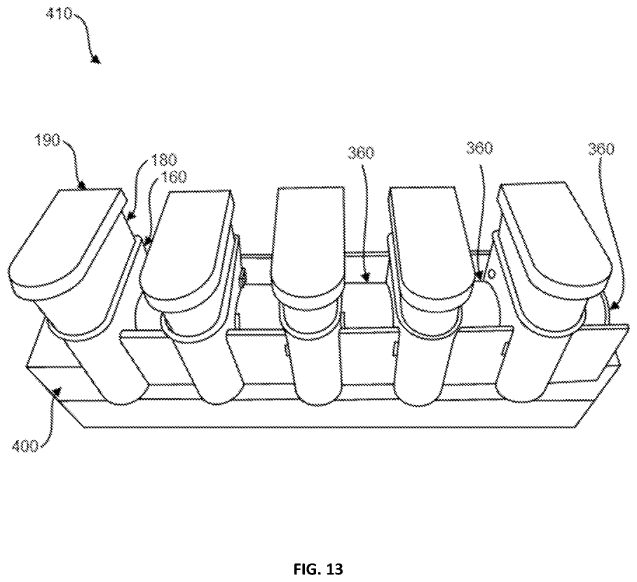

FIG. 13 shows the assembly 410 of the five pill dispensing units 150 with the pill holding chambers 180 and the lids 190.

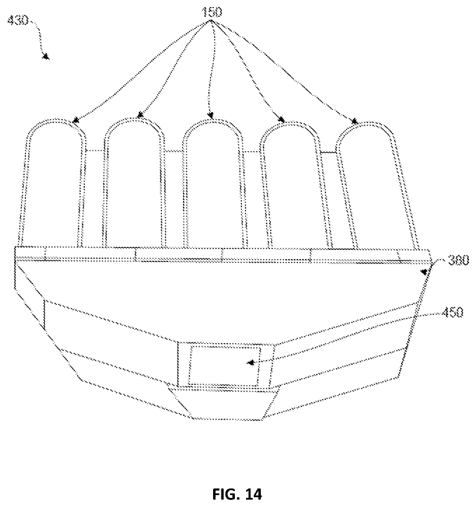

FIG. 14 shows a bottom view of the assembly 430 of five units showing the pill receiving funnel module 380 to dispense pills in the cup underneath (not shown). The opening 450 at the bottom of the funnel 380 allows the dropping of the pills in the cup underneath.

### EXAMPLES

The pill dispenser system was tested for proper functionality, such as proper rotation of the wheel by the motor and the connectivity of the Android™ app to the system. 50 pills in the pill holder were placed and pills were dropped one at a time in the wheel groove upon rotation of the wheel when the command is given from the Android™ app. The rate of successful pill dispensing events were counted. The experiment was repeated three times.

Pills of two different sizes were tested for dispensing. The current prototype of the pill dispenser could dispense a “6 mm diameter×3 mm thick” round pill and a “11 mm×6 mm×4 mm” oval pill using two different custom grooves on the wheel/gear to receive pills from the chamber above with 100% accuracy.

TABLE 1
“6 mm diameter × 3 mm thick” round pills.
50 pill counts were used for each test.

| Expt # | Pills dispensed | Pills not dispensed | Success rate (%) |
|---|---|---|---|
| 1 | 50 | 0 | 100% |
| 2 | 50 | 0 | 100% |
| 3 | 50 | 0 | 100% |
| | | | Average (100%) |
| | | | S.D. (0%) |

TABLE 2
“11 mm × 6 mm × 4 mm” oval pills. 50
pill counts were used for each test.

| Expt # | Pills dispensed | Pills not dispensed | Success rate (%) |
|---|---|---|---|
| 1 | 50 | 0 | 100% |
| 2 | 50 | 0 | 100% |
| 3 | 50 | 0 | 100% |
| | | | Average (100%) |
| | | | S.D. (0%) |

1. A system for dispensing pills comprising: an assembly of a pill dispensing unit, an electrical system, and a cell phone application on a cell phone to control the operation of the pill dispensing unit, wherein the pill dispensing unit is connected to the electrical system and the cell phone application is connected to the system via a Wi-Fi™.

2. The system of claim 1, wherein the system contains 1-50 pill dispensing units connected to the electrical system.

3. The system of claim 2, wherein the system contains 2-10 pill dispensing units.

4. The system of claim 1, wherein the cell phone is an iPhone™ or an Android™ phone.

5. The system of claim 1, wherein the cell phone application is an Android™ application written in Javascript Object Notation.

6. The system of claim 1, wherein the electrical system comprises an Arduino™ board or a microchip.

7. The system of claim 1, wherein the electrical system comprises the Arduino™ board, a real time clock module, a Wi-Fi™ module, a stepper motor, a Darlington array, or a power transistor, wherein the real time clock module and the stepper motor is connected to the Arduino™ board via a breadboard.

8. The system of claim 1, wherein the pill dispensing unit comprises a wheel, an encasing for the wheel, a pill holding chamber, a sloping pill base containing an opening to allow pills to pass through, and a lid, assembled as shown in FIG. 4.

9. The system of claim 8, wherein the wheel contains an opening and connected to the stepper motor via the opening as shown in FIG. 11.

10. The system of claim 8, wherein the wheel is freely rotatable.

11. The system of claim 8, wherein the wheel contains one or two or three grooves of different sizes.

12. The system of claim 11, wherein the wheel contains one groove.

13. The system of claim 8, wherein corners of the pill holding chamber can be either rounded or at 90° angle.

14. The system of claim 1, wherein the system contains a pill receiving funnel module.

15. The system of claim 1, wherein the system is either powered by a 9V battery or powered by direct supply of power via an electrical outlet.
